(19) United States
(12) Patent Application Publication
(10) Pub. No.: US 2026/0036476 A1
(43) Pub. Date: Feb. 5, 2026

(54) METHODS AND APPARATUS TO SIMULATE TORQUE

(71) Applicant: The Boeing Company, Arlington, VA (US)

(72) Inventors: Curtis Raymond Estevo, Jr., Mesa, AZ (US); Grace Catherine Rosenvall, Gilbert, AZ (US); Hope Justin Bennett, Phoenix, AZ (US)

(21) Appl. No.: 18/788,973

(22) Filed: Jul. 30, 2024

(51) Int. Cl. G01L 3/18; B23Q 17/09

(52) U.S. Cl. CPC G01L 3/18; B23Q 17/0904

(57) ABSTRACT

Methods and apparatus to simulate torque are disclosed. A disclosed example apparatus to characterize a tool includes a tool interface to be couplable to the tool, a brake to apply a rotational resistance to the tool interface, and a transducer to measure an output torque of the tool for characterization of the tool with respect to the rotational resistance.

### FIELD OF THE DISCLOSURE

This disclosure relates generally to manufacturing testing and, more particularly, to methods and apparatus to simulate torque.

### BACKGROUND

Measurement of the run-on torque, which is a torque required to overcome dynamic friction between elements of a fastened joint during fastening/tightening, can play a crucial role in ensuring that a proper clamp load has been applied to a joint. Known methodology involves utilizing multiple different implementations of manual wrenches for each fastening operation, and can necessitate a duration of one to two minutes for completion. In contrast, transducer-based power tools enable fastening in a single step with a corresponding duration of a few seconds. However, industry standards for calibrating tools to measure these dynamic torque values and validate the torque strategies can necessitate rigorous testing of each type of joint to be fastened.

### SUMMARY

An example apparatus includes a tool interface to be couplable to the tool, a brake to apply a rotational resistance to the tool interface, and a transducer to measure an output torque of the tool for characterization of the tool with respect to the rotational resistance.

An example non-transitory machine-readable medium includes machine-readable instructions to cause at least one processor circuit to at least control a degree of braking of a rotational resistor, the rotational resistor to provide a force to a tool interface operatively coupled to a tool, determine an output of the tool corresponding to the controlled degree of braking, and characterize the tool based on the output and at least one of the (i) the force or (ii) the degree of braking.

An example method of characterizing a tool includes causing the tool to rotate at a defined setting, imparting a braking force at an interface of the tool, measuring an output at the interface of the tool, and comparing the output to the braking force to characterize the tool.

### BRIEF DESCRIPTION OF THE DRAWINGS

FIG. 1 depicts an example torque simulator in accordance with teachings of this disclosure.

FIG. 2 depicts a detailed bottom view of the example torque simulator of FIG. 1.

FIGS. 3A-3C depict example contact tips that can be implemented in examples disclosed herein.

FIGS. 4A-4C depict alternative torque simulators in accordance with teachings of this disclosure.

FIG. 5 is an example control system in accordance with teachings of this disclosure.

FIG. 6 is a block diagram of an example implementation of an example torque analysis system that can be implemented in examples disclosed herein.

FIG. 7 is a flowchart representative of example machine readable instructions and/or example operations that may be executed, instantiated, and/or performed by example programmable circuitry to implement the torque analysis system of FIG. 6.

FIG. 8 is a block diagram of an example processing platform including programmable circuitry structured to execute, instantiate, and/or perform the example machine readable instructions and/or perform the example operations of FIG. 7 to implement the torque analysis system of FIG. 6.

FIG. 9 is a block diagram of an example implementation of the programmable circuitry of FIG. 8.

FIG. 10 is a block diagram of another example implementation of the programmable circuitry of FIG. 8.

FIG. 11 is an example graph depicting example results corresponding to examples disclosed herein.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus to simulate torque are disclosed. Currently, industry standards for testing transducer-based power torque tools at specific speeds and torque values for validating a run-down portion of a torque strategy do not exist. In some known implementations, a test bench can recreate real world data. However, in these known implementations, run-down scenarios at specified torques and speeds, which can be beneficial for calibration and validation of a tool for a full window of a given torque specification, are not generated.

Examples disclosed herein enable simulation of specified dynamic torque values at various parameters including rotational rates/speeds or rotations per minute (RPM) to validate tool calibrations and torque strategies. According to examples disclosed herein, a torque simulator includes a transducer (e.g., a stand alone torque transducer), a mechanism/device and/or assembly to provide a relatively constant, yet adjustable, rotational resistance, and an input/interface for a torque tool. In accordance with teachings of this disclosure, a transducer-based power tool can be set to run for a specified duration or number of revolutions (e.g., at a specified speed). According to examples disclosed herein, the torque simulator provides a specified and relatively constant amount of resistance (e.g., frictional force or resistance, etc.), which can be measured by a known, calibrated, and approved test standard (e.g., a test standard corresponding to the tool, a test standard for an in-line transducer independent of the tool, etc.). In some examples, if a statistical comparison of two torque curves (e.g., a comparison between a measured torque curve and a specified/reference torque curve, etc.) is acceptable, the tool is determined to be operating reliably with respect to dynamic torque. This can be accomplished for a full range of a given specification to validate a tool across the entire range.

Examples disclosed herein utilize a tool interface that is operatively coupled to a brake. The tool interface is utilized to interface with a tool and the aforementioned brake is utilized to provide an applied counter-torque and/or rotational resistance to the tool interface. Additionally or alternatively, the brake includes a magnetic brake or other electronically controlled device to impart a controlled frictional torque to the tool interface. According to examples disclosed herein, the brake is utilized to maintain a relatively constant counter-torque and/or frictional torque to the tool interface and, thus, the tool. In turn, torque and/or output of the tool is measured as the tool is operated at a set output (e.g., at a defined rotational speed, for a defined number of rotations, etc.). According to some examples disclosed herein, a torque curve and/or a history is generated with respect to the tool as the tool is operated to counteract the resistance from the brake. In turn, the torque curve and/or history can be compared to a second torque curve for characterization, evaluation, calibration and/or adjustment of the tool. In a particular example, the first torque curve is statistically compared to the second torque curve.

In some examples, the brake includes a weight/mass that is operatively coupled to a rotatable shaft. In turn, the rotatable shaft is operatively coupled to a tool interface. In some such examples, the rotatable shaft includes grooves and/or threads to guide a line (e.g., a rope, a string, a tether line, etc.) holding the weight/mass as the weight/mass is hung from the rotatable shaft under the influence of gravity (e.g., the weight/mass is hung off of a platform or table, etc.). In some examples, a movable arm is rotated to contact and/or interface with the brake for simulation of a joint condition, such as a fastener being torqued during an assembly operation. In some such examples, the brake is enabled to rotate freely until the movable arm is moved (e.g., rotated) to contact a surface (e.g., an indented surface) corresponding to the tool interface. In particular, a tip (e.g., an elastic tip, a contoured tip, a spring-loaded tip, etc.) of the movable arm may contact a surface of a rotatable contoured body that is operatively coupled to the tool interface (e.g., at least a portion of the movable arm is inserted into a recess or divot of the contoured body), thereby reducing and/or impeding a rotational movement of the brake to simulate the joint condition. In some such examples, the rotatable contoured body is operatively coupled to the tool interface, whereby the tool interface and the rotatable contoured body rotate together.

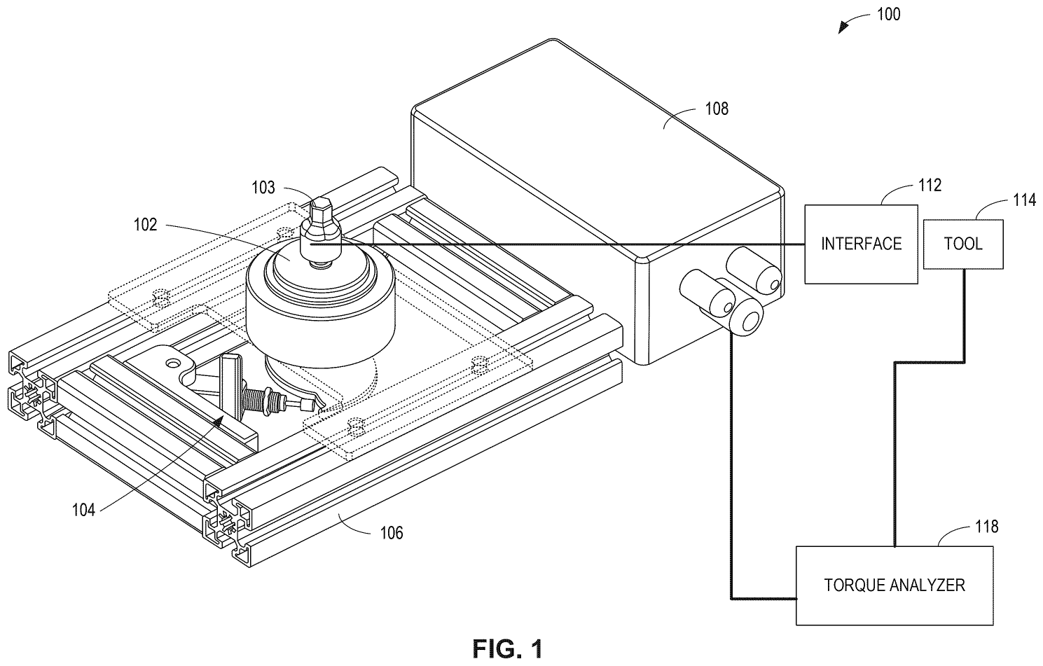

FIG. 1 depicts an example torque simulation device 100 in accordance with teachings of this disclosure. The example torque simulation device 100 utilizes an electronic braking system for characterization, validation and/or calibration of a tool. The example torque simulation device 100 includes a brake (e.g., a magnetic brake, an electronic brake, an electric brake, etc.) 102 that supports a brake interface 103, a joint simulator 104, a support frame (e.g., a chassis, a test frame, etc.) 106 and a power supply 108 for powering the brake 102. In the illustrated example of FIG. 1, the brake 102 and/or the brake interface 103 interfaces with a tool interface 112 of an example tool (e.g., a torque tool, a torque driver, a torque fastener device, etc.) 114.

To control a degree of braking and/or rotational resistance provided to the tool interface 103, a controlled amount of current is provided from the power supply 108 to the brake 102. In other words, a frictional and/or resistive rotational force of the brake 102 is varied based on an amount of current provided thereto. Accordingly, the brake 102 can enable appropriate and controlled frictional and/or resistive torque to the tool 114. In some examples, the resistive torque and/or rotational resistance of the tool 114 being characterized can be based on an operational mode (e.g., a tool setting, a torque setting, a speed setting, a current setting, a defined setting, a pre-defined setting, etc.) of the tool 114.

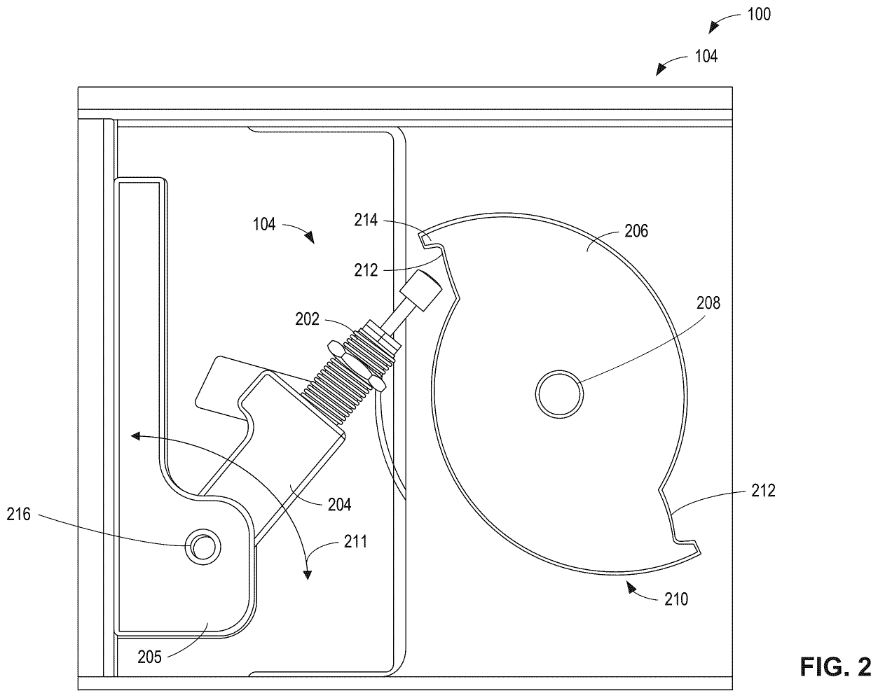

In operation, the interface 112 of the tool 114 is operatively coupled to (e.g., releasably coupled to, rotatably coupled to, etc.) the brake 102 and/or the tool interface 103. In this example, as the tool 114 rotates, the torque analyzer 118 determines, measures and/or measures an amount of torque, current, speed (or other output parameter) of the tool 114 for characterization of the tool 114 (e.g., characterization based on different resistance settings). In some examples, the interface 112 includes and/or is communicatively coupled to a sensor, such as a transducer, for example. According to some examples disclosed herein, the torque analyzer 118 may be implemented to analyze, characterize and/or calibrate the tool 114 (e.g., based on set points and/or settings of the tool 114). In some examples, the torque analyzer 118 determines an adjustment of the tool 114 and/or a torque offset so that the tool 114 provides a proper and/or requisite degree of torque output for subsequent operations and/or uses. As will be discussed in greater detail below in connection with FIGS. 2-7, the aforementioned joint simulator 104 is utilized to characterize the tool 114 during tightening (e.g., torquing of a fastener with the tool 114, preload application, etc.).

FIG. 2 depicts a detailed bottom view of the example joint simulator 104 of the torque simulation device 100 of FIG. 1. In this example, the example joint simulator 104 includes a tip (e.g., a contact tip) 202, a movable arm (e.g., a rocker arm, a swivel arm, etc.) 204 and a support base (e.g., an arm pivot, an arm support, a frame, etc.) 205. Further, the joint simulator 104 of the illustrated example includes a rotatable body 206 that rotates about a pivot (e.g., a rotational joint, a rotational coupling, a pivot coupling, etc.) 208, as generally indicated by a double arrow 211. In turn, the example rotatable body 206 includes a curved contour (e.g., a curved surface) 210, at least one interface surface 212 and a tab (e.g., a distal end tab, a diametric tab, etc.) 214. In this example, the movable arm 204 is rotationally coupled to the support base 205 at a pivot (e.g., a rotational pivot, a rotational joint, a swivel joint, etc.) 216.

In the illustrated example of FIG. 2, to simulate a torque-down and/or securing of a fastener for a tool, such as the tool 114 shown in FIG. 1, the tip 202 is caused to contact the interface surface 212 by rotating the movable arm 204 about the pivot 216. For example, the tool rotates the rotatable body 206 about the pivot 208 by interfacing with the tool interface 103 shown in FIG. 1, and rotation of the movable arm 204 toward the rotatable body 206 causes the tip 202 to contact the surface 212, thereby impeding motion of the rotatable body 206 and, in turn, the tool 114. In some examples, the tab 214 interacts with the tip to stop, impede, resist and/or prevent rotation of the rotatable body 206 (and the tool).

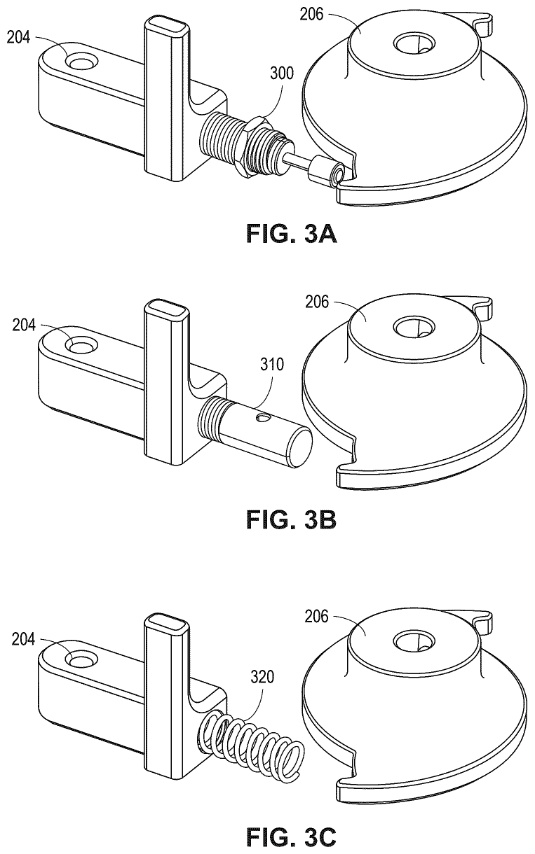

FIGS. 3A-3C depict example contact tips 300, 310, 320 that can be implemented in examples disclosed herein. The contact tips 300, 310, 320 can be implemented in the example tip 202 shown in FIG. 2. Turning to FIG. 3A, the example tip 300 is shown operatively coupled to the movable arm 204. In the illustrated example of FIG. 3A, the tip 300 is a short-stroke shock absorber that can simulate a hard/semi hard joints with minimal or reduced stack up compression, for example. This shock absorber can be implemented as a spring, damper or other force-inducing mechanism/device for contact with the rotatable body 206.

FIG. 3B depicts the aforementioned example tip 310 operatively coupled to the movable arm 204. According to examples disclosed herein, the tip 310 is a threaded rod, which may be at least partially composed of steel or other appropriate metal, for example, to contact the rotatable body 206. In the illustrated example of FIG. 3B, the tip 310 simulates a hard joint with relatively little compression in a stack up. In examples, a length of the threaded rod is adjustable (e.g., by rotating a cap/nut at a distal end thereof).

Turning to FIG. 3C, the example tip 320 is shown operatively coupled to the movable arm 204. In this example, the tip 320 is implemented as a spring (e.g., a light spring) or a relatively soft rubber and/or elastomer. Accordingly, the example tip 320 can simulate a relatively soft joint that is similar to a compressing gasket or tube fitting, etc. In some examples, a spring of the tip 320 can be interchanged and/or swapped with another spring to adjust a resistive rotational force applied to the rotatable body 206.

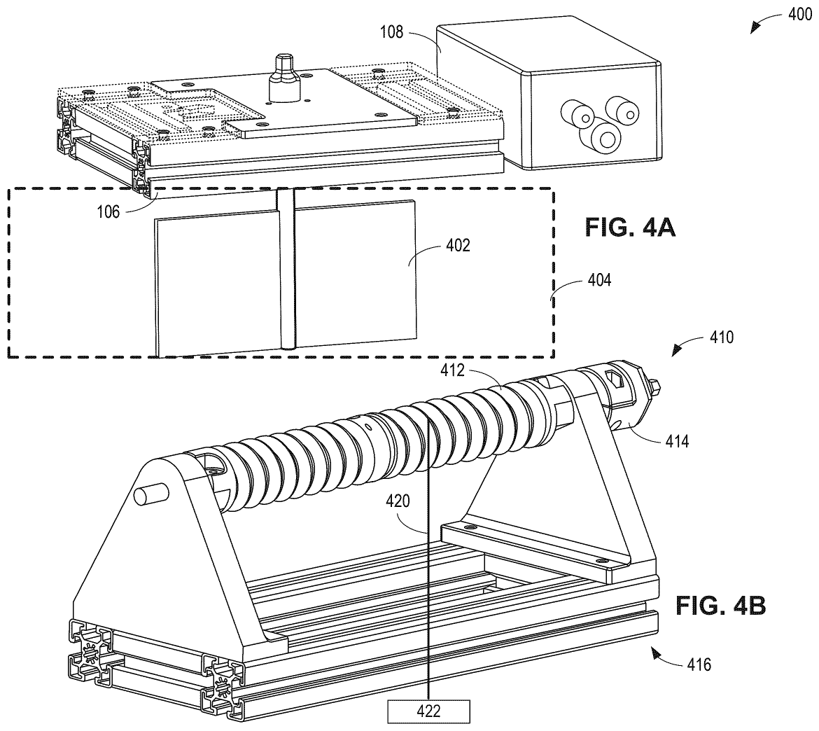

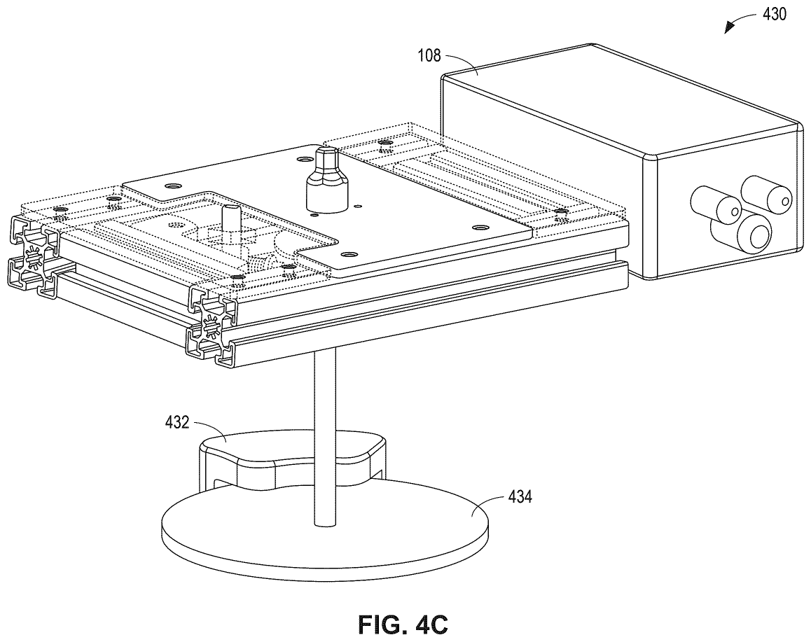

FIGS. 4A-4C depict alternative example torque simulator implementations. Turning to FIG. 4A, an example torque simulator 400 is shown in a hydraulic implementation with the support frame 106 and the power supply 108 of FIG. 1. According to some examples disclosed herein, a brake 402 is implemented as a paddle and hereby referred to as the “paddle 402.” The example paddle 402 is implemented to be placed in a reservoir or pool 404 of fluid (below the support frame 106 in the view of FIG. 4A), for example. In particular, a shaft and, in turn, the paddle 402 coupled to the shaft is rotated and/or turned as the paddle 402 is placed and/or inserted into a fluid bath (e.g., at least partially submerged in the fluid bath) of the pool 404 such that input torque imparted to the tool is influenced by a size of the paddle (e.g., a surface area of the paddle), viscosity of the fluid, and/or depth of the pool 404 to which the paddle 402 is submerged (e.g., a fluid level).

FIG. 4B depicts an alternative example torque simulator 410. In this example, the torque simulator 410 includes a brake 412, which is implemented as a threaded shaft 412 and hereby referred as the “threaded shaft 412.” The example torque simulator 410 also includes an interface (e.g., a tool interface) 414, a support frame 416, and a line (e.g., a string, a tether, a support line, etc.) 420 with a weight 422 attached thereto. In this example, the shaft 412 includes threaded exterior surfaces (e.g., threaded diametric surfaces) and/or shapes.

In operation, a tool (e.g., the tool 114 of FIG. 1) that is operatively coupled to the interface 414 causes the threaded shaft 412 to rotate and, in turn, the line 420 moves the weight 422. Particularly, the rotation of the shaft 412 and an interaction of the line 420 in conjunction with the threads of the threaded shaft 412 causes movement of the aforementioned weight 422 upward (in the view of FIG. 4B). In this example, the weight 422 hangs (e.g., hangs off of a surface on which the torque simulator 410 sits, hangs off a table/desk surface, a fixture, etc.) under the influence of gravity via the line 420. In other words, the torque and/or rotational force applied to the tool interface 414 and, thus, the tool is controlled based on the weight 422 being moved upward/downward due to rotation of the threaded shaft 412. To that end, the weight 422 can be swapped and/or added/removed to adjust an amount of rotational force counteracting movement caused by the tool. In this example, a relatively constant inner diameter of the threads enables a relatively constant force of the weight 422 to be applied to the threaded shaft 412 (while the threaded shaft 412 rotates).

Turning to FIG. 4C, an example torque simulator 430 is shown with the power supply 108 of FIG. 1. According to some examples disclosed herein, a brake (e.g., a disc brake) 432, which is implemented as a mechanical brake, can include a disc or a drum 434. In the illustrated example of FIG. 4C, once a rotational speed of a tool is set and/or controlled, the brake 432 can be gradually applied until a desired/specified resistance torque has been met. In a particular example, a disc brake can be utilized to control a degree of resistive torque with respect to a tool being tested and/or evaluated (e.g., via a braking function or other time-based braking steps, etc.).

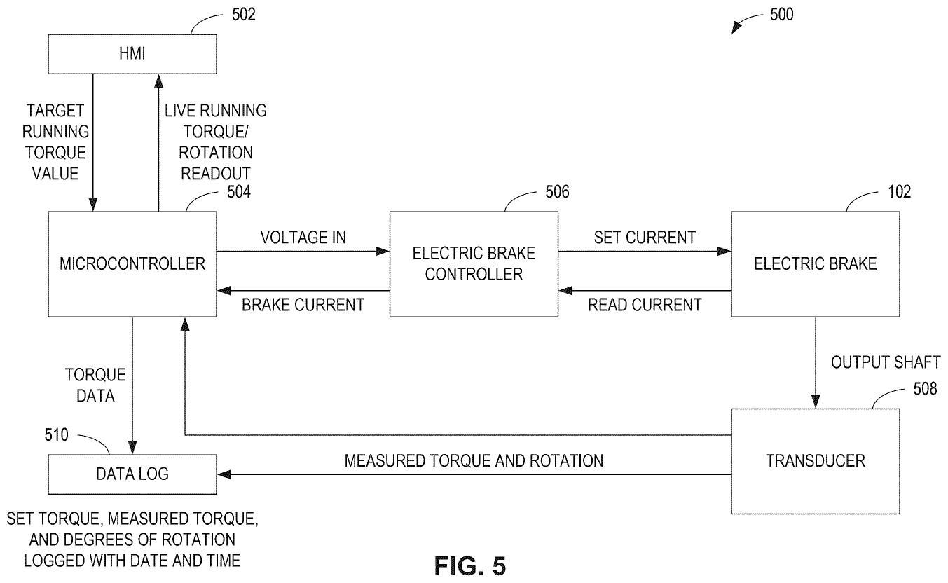

FIG. 5 is an example control system 500 in accordance with teachings of this disclosure. The example control system 500 includes a human machine interface (HMI) 502, which can act as user interface for an operator, a microcontroller 504, a brake controller (e.g., an electric brake controller, an electronic brake controller, etc.) 506, a transducer 508, a data log (e.g., a data storage) 510, and the brake 102 of FIG. 1.

In operation, the example HMI 502 is utilized to define a set point (e.g., a target running torque value) to the microcontroller 504. Further, the microcontroller 504 provides “live” torque/rotation readout data to the HMI 502 for display to the operator. In turn, the example microcontroller 504 provides torque data to the data log 510. In this example, the brake controller 506 receives a voltage from the microcontroller 504 and, accordingly, returns a brake current (e.g., a brake current value) to the microcontroller 504. According to examples disclosed herein, the brake controller 506 provides a set current to the brake 102 and receives a read current (e.g., a read current value) from the brake 102. In this example, the brake 102 is operatively coupled to a transducer 508 via an output shaft and/or interface. In turn, the transducer 508 of the illustrated example provides measured torque and rotation values to the data log 510 as well as the microcontroller 504. According to some examples disclosed herein, the data log 510 can be utilized to store data and/or parameters such as, but not limited to, a set torque (e.g., set torque value(s)), a measured torque, degrees of rotation, torque curve values and date/time, etc.

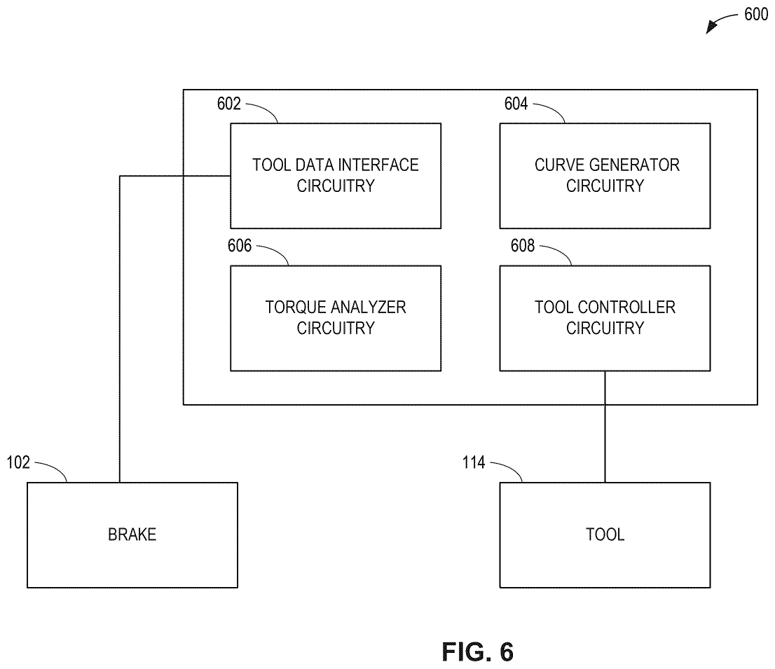

FIG. 6 is a block diagram of an example implementation of an example torque analysis system 600 to analyze and/or characterize a torque output and/or control of a tool, such as a torque driver, for example. The example torque analysis system 600 can be implemented in the brake 102, the torque analyzer/controller 118, the microcontroller 504 and/or the brake controller 506. The torque analysis system 600 of FIG. 6 may be instantiated (e.g., creating an instance of, bring into being for any length of time, materialize, implement, etc.) by programmable circuitry such as a Central Processor Unit (CPU) executing first instructions. Additionally or alternatively, the torque analysis system 600 of FIG. 6 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 6 may, thus, be instantiated at the same or different times. Some or all of the circuitry of FIG. 6 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

The torque analysis system 600 of the illustrated example includes example tool data interface circuitry 602, example curve generator circuitry 604, example torque analyzer circuitry 606, and example tool adjuster circuitry 608. According to some examples disclosed herein, the torque analysis system 600 includes and/or is communicatively coupled to the torque analyzer 118, the microcontroller 504 and/or the brake controller 506.

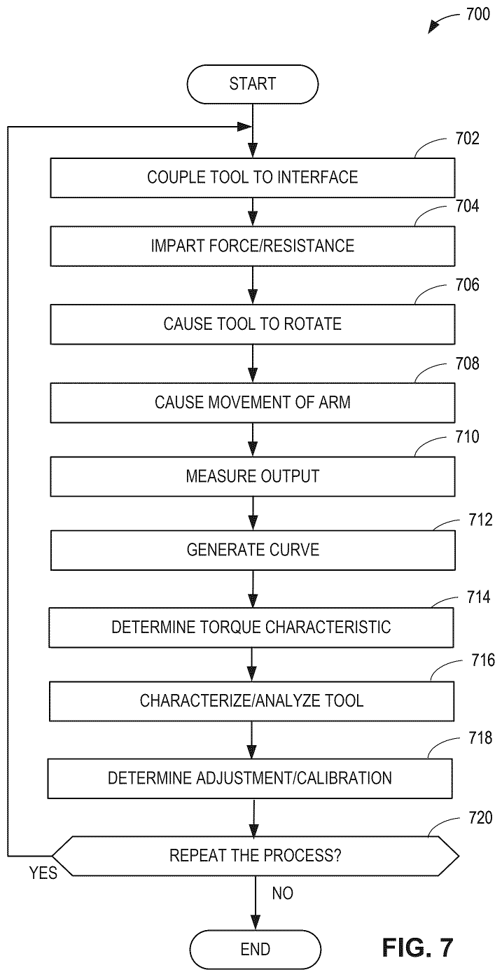

The example tool data interface circuitry 602 is implemented to obtain and/or access data corresponding to a tool (e.g., the tool 114). In this example, the tool data interface circuitry 602 records torque information of the tool as the tool is operated (e.g., via the microcontroller 504, the electronic brake controller 506, the transducer 508 and/or the data log 510). According to some examples disclosed herein, the tool data interface circuitry 602 is associated with (e.g., communicatively coupled to) a transducer that is operatively coupled to the tool. In some examples, the tool data interface circuitry 602 is instantiated by programmable circuitry executing tool data interface circuitry instructions and/or configured to perform operations such as those represented by the flowchart of FIG. 7.

According to some examples disclosed herein, the curve generator circuitry 604 is implemented to generate curves and/or arrays for characterization of the tool (e.g., a torque characteristic of the tool, transient behavior of the tool, etc.). In this example, the curve generator circuitry 604 is implemented to generate a curve, table and or an array corresponding to a torque of the tool with respect to an angular rotation (e.g., a rotational displacement, an angular displacement, etc.) of the tool as the tool is operated (e.g., with a controlled or known resistive torque motion applied to the tool). In this example, the curve generator circuitry 604 can correlate output torque values of the tool with set points thereof (e.g., measured transducer torque values are correlated with set points of the tool, etc.). In some examples, the curve generator circuitry 604 is instantiated by programmable circuitry executing curve generator instructions and/or configured to perform operations such as those represented by the flowchart of FIG. 7.

In the illustrated example, the torque analyzer circuitry 606 characterizes and/or analyzes the tool based on the data corresponding to the tool as the tool is operated. According to examples disclosed herein, the torque analyzer circuitry 606 characterizes the tool with respect to an applied resistive torque applied thereto. For example, the torque analyzer circuitry 606 characterizes the tool by relating an output torque of the tool with respect to a resistive force applied at an interface to the tool. In some examples, the torque analyzer circuitry 606 compares a torque curve obtained with the tool that is urged by the resistive torque/motion to another torque curve (e.g., a standard torque curve, a reference torque curve, a torque specification curve, etc.) and/or at least one threshold. In some examples, the torque analyzer circuitry 606 is instantiated by programmable circuitry executing torque analyzer instructions and/or configured to perform operations such as those represented by the flowchart of FIG. 7.

In some examples, the tool adjuster circuitry 608 is implemented to determine an adjustment and/or a calibration of the tool based on the characterization and/or analysis of the tool. According to some examples disclosed herein, the tool adjuster circuitry 608 is utilized to adjust output parameters of tool based on the aforementioned characterization of the tool. Additionally or alternatively, the tool adjuster circuitry 608 is utilized to control and/or adjust an output of the tool based on the characterization. In some examples, the tool adjuster circuitry 608 is instantiated by programmable circuitry executing tool adjuster instructions and/or configured to perform operations such as those represented by the flowchart of FIG. 7.

While an example manner of implementing the torque analysis system 600 of FIG. 6 is illustrated in FIG. 6, one or more of the elements, processes, and/or devices illustrated in FIG. 6 may be combined, divided, re-arranged, omitted, eliminated, and/or implemented in any other way. Further, the example tool data interface circuitry 602, the example curve generator circuitry 604, the example torque analyzer circuitry 606, the example tool controller circuitry 608, and/or, more generally, the example torque analysis system 600 of FIG. 6, may be implemented by hardware alone or by hardware in combination with software and/or firmware. Thus, for example, any of the example tool data interface circuitry 602, the example curve generator circuitry 604, the example torque analyzer circuitry 606, the example tool controller circuitry 608, and/or, more generally, the example torque analysis system 600, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example torque analysis system 600 of FIG. 6 may include one or more elements, processes, and/or devices in addition to, or instead of, those illustrated in FIG. 6, and/or may include more than one of any or all of the illustrated elements, processes and devices.

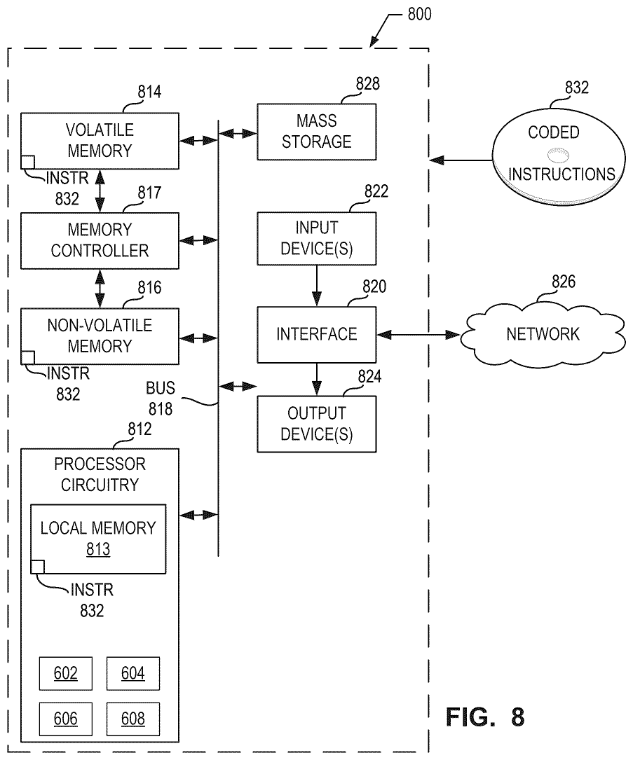

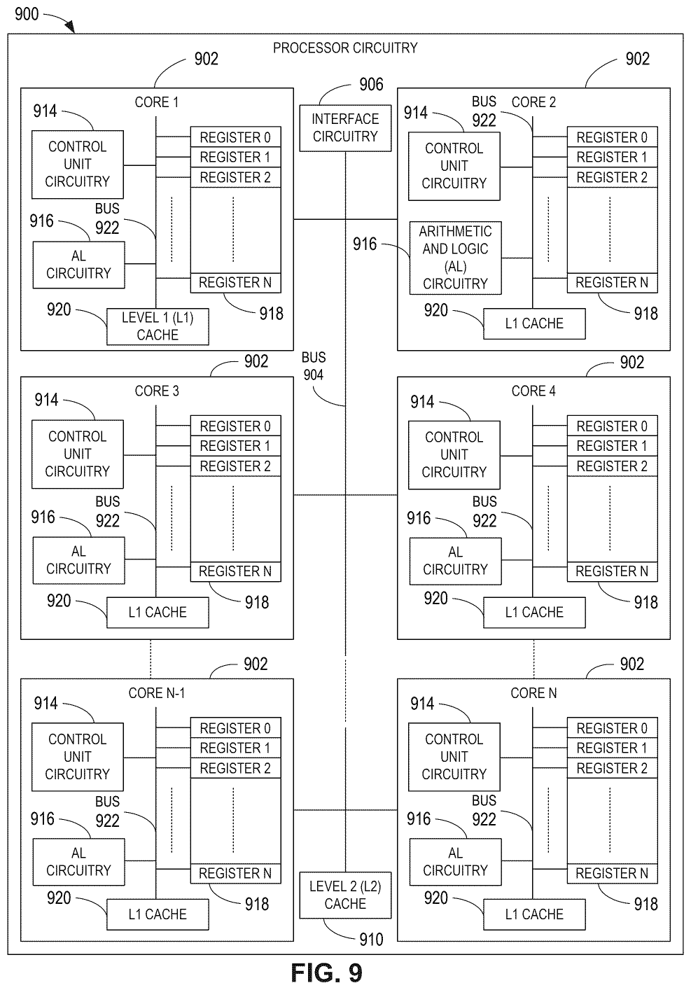

A flowchart representative of example machine readable instructions, which may be executed by programmable circuitry to implement and/or instantiate the torque analysis system 600 of FIG. 6 and/or representative of example operations which may be performed by programmable circuitry to implement and/or instantiate the torque analysis system 600 of FIG. 6, is shown in FIG. 7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart illustrated in FIG. 7, many other methods of implementing the example torque analysis system 600 may alternatively be used. For example, the order of execution of the blocks of the flowchart may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIG. 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 7 is a flowchart representative of example machine readable instructions and/or example operations 700 that may be executed, instantiated, and/or performed by programmable circuitry to characterize and/or adjust a tool (e.g., the tool 114). The example machine-readable instructions and/or the example operations 700 of FIG. 7 begin at block 702, at which the tool data interface circuitry 602 causes the tool to be coupled to a tool interface (e.g., the tool interface 112) and/or a brake (e.g., the brake 102. the brake 402, the brake 412, the brake 432, etc.).

At block 704, the example tool data interface circuitry 602 causes the brake to impart a resistive force to the tool and/or the tool interface. In this example, the tool data interface circuitry 602 causes a motor or other braking device to provide a controlled degree of braking and/or resist rotational motion of the tool. According to some examples disclosed herein, the level and/or degree of the resistive rotational motion applied to the tool is pre-determined and/or controlled (e.g., for characterization and/or calibration of the tool).

At block 706, the tool controller circuitry 608 of the illustrated example causes the tool to rotate. In this example, the tool controller circuitry 608 controls a rotational speed of the tool and/or directs the tool to maintain a rotational speed thereof. Additionally or alternatively, the tool controller circuitry 608 determines a setting of the tool for characterization of the tool (e.g., a setting of the tool to be tested and/or characterized, etc.).

At block 708, in some examples, the tool data interface circuitry 602 and/or the tool controller circuitry 608 of the illustrated example causes movement and/or rotation of a movable arm (e.g., the movable arm 204) to cease movement and/or rotation of the tool (e.g., to simulate a torque down condition, a tightening condition or a clamping condition, etc.). In this example, the movable arm is moved (e.g., via an actuator, solenoid, etc.) to contact a contoured body operatively coupled to the tool interface and/or the tool to simulate a joint condition (e.g., tightening/torquing of a bolt or other fastener, etc.).

At block 710, the example tool data interface circuitry 602 and/or the example curve generator circuitry 604 causes a sensor (e.g., a transducer, a torque sensor, etc.) to measure an output, such as a torque (e.g., periodically, a historical measurement, etc. of torque), with respect to an angular displacement (e.g., a cumulative degree of angular rotation) of the tool. However, any other appropriate other parameter and/or output of the tool can be measured instead.

At block 712, in some examples, the curve generator circuitry 404 generates at least one torque curve. In the illustrated example of FIG. 7, the curve generator circuitry 604 of the illustrated example can generate a torque curve that corresponds to an angular displacement of the tool and/or a tool interface with respect to time. Subsequently the torque curve can be compared to (e.g., statistically compared to) threshold values, etc.

At block 714, the example torque analyzer circuitry 606 compares a measured output of the tool to a threshold and/or standard to determine a torque characteristic and/or characterize the tool. In a particular example, the aforementioned torque analyzer circuitry 606 compares a measured torque curve to a standard torque curve (e.g., a reference torque curve, a reference curve, a reference value, etc.) to characterize the tool (e.g., determine a torque characteristic of the tool). In some examples, the torque analyzer circuitry 606 performs a statistical analysis between the measured torque curve and the standard torque curve.

At block 716, example torque analyzer circuitry 606 characterizes and/or analyzes the tool based on the comparison. For example, the torque analyzer circuitry 606 determines whether the tool is operating within specification based on the comparison and/or a degree of similarity between the measured torque curve and the standard torque curve.

At block 718, in some examples, the tool adjuster circuitry 608 determines an adjustment and/or calibration of the tool based on the characterization of the tool and/or the comparison between the measured torque curve and the standard torque curve.

At block 720, it is determined by the tool adjuster circuitry 608 whether to repeat the process. If the process is to be repeated, control of the process returns to block 702. Otherwise, the process ends. The determination may be based on whether additional adjustment/calibration is necessitated and/or whether additional tools are to be characterized.

FIG. 8 is a block diagram of an example programmable circuitry platform 800 structured to execute and/or instantiate the example machine-readable instructions and/or the example operations of FIG. 7 to implement the torque analysis system 600 of FIG. 6. The programmable circuitry platform 800 can be, for example, a server, a personal computer, a workstation, a self-learning machine (e.g., a neural network), a mobile device (e.g., a cell phone, a smart phone, a tablet such as an iPad™), a personal digital assistant (PDA), a set top box, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the example tool data interface circuitry 602, the example curve generator circuitry 604, the example torque analyzer circuitry 606 and the example tool controller circuitry 608.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIG. 7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowchart of FIG. 7 to effectively instantiate the circuitry of FIG. 6 as logic circuits to perform operations corresponding to those machine readable instructions. In some such examples, the circuitry of FIG. 6 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowchart of FIG. 7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

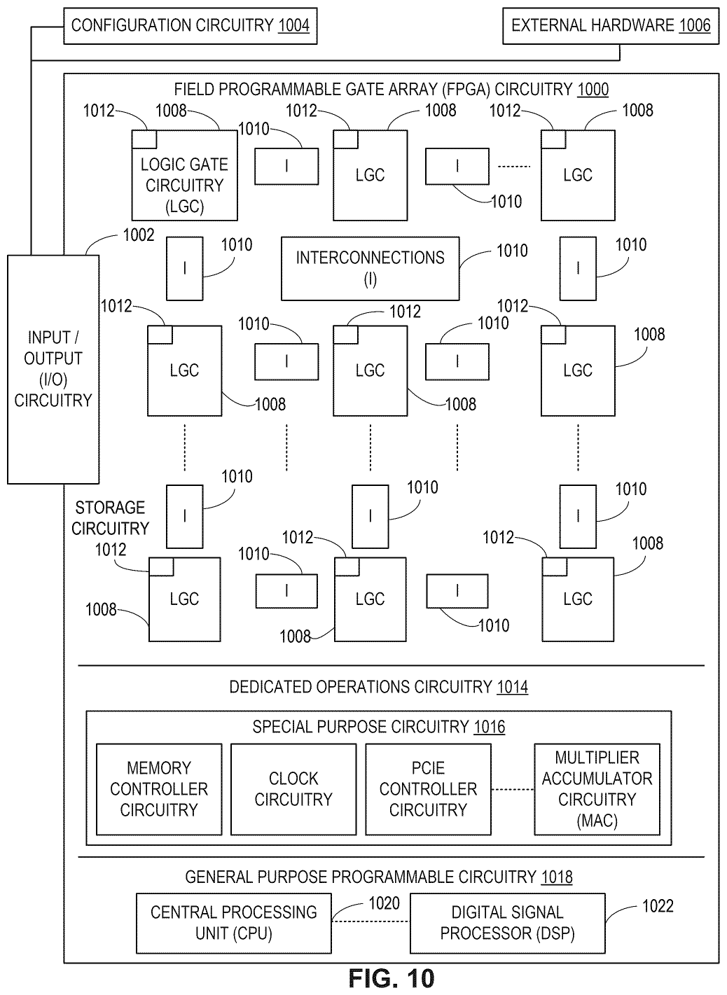

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart of FIG. 7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart of FIG. 7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 7. As such, the FPGA circuitry 1000 may be configured and/or structured to effectively instantiate some or all of the operations/functions corresponding to the machine readable instructions of the flowchart of FIG. 7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIG. 7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIG. 7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart of FIG. 7 to perform first operation(s)/function(s), the FPGA circuitry 1000 of FIG. 10 may be configured and/or structured to perform second operation(s)/function(s) corresponding to a second portion of the machine readable instructions represented by the flowchart of FIG. 7, and/or an ASIC may be configured and/or structured to perform third operation(s)/function(s) corresponding to a third portion of the machine readable instructions represented by the flowchart of FIG. 7.

It should be understood that some or all of the circuitry of FIG. 6 may, thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 6 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 6 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages. In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

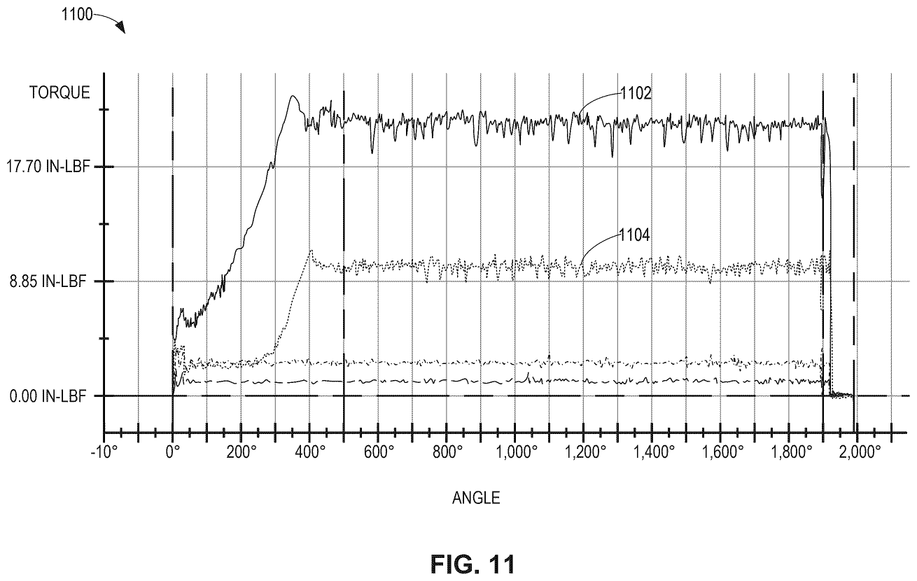

FIG. 11 is an example graph 1100 depicting example results corresponding to examples disclosed herein. In particular, the example graph 1100 depicts a history of torque values measured at a tool (e.g., via an inline torque sensor) with respect to rotations of the tool. As can be seen in the illustrated view of FIG. 11, a first curve 1102 corresponds to a first torque response with a first rotational resistance and, likewise, a second curve 1104 corresponds to a second torque response with a second rotational resistance that is less than the first rotational resistance. According to examples disclosed herein, the first curve 1102 and/or the second curve 1104 can be compared to corresponding standard/reference curves to characterize, determine and/or analyze an operating condition of the tool. In other words, the tool can be characterized based on a comparison of torque curves that may entail determining an offset or a statistical analysis therebetween, for example.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable effective testing transducer-based power torque tools are disclosed herein. Further examples and combinations thereof include the following:

Example 1 includes an apparatus to characterize a tool, the apparatus comprising a tool interface to be couplable to the tool, a brake to apply a rotational resistance to the tool interface, and a transducer to measure an output torque of the tool for characterization of the tool with respect to the rotational resistance.

Example 2 includes the apparatus as defined in example 1, further including interface circuitry, machine-readable instructions, and at least one processor circuit to be programmed by the machine-readable instructions to compare the output torque to a threshold, and determine the characterization of the tool based on the comparison.

Example 3 includes the apparatus as defined in example 2, wherein one or more of the at least one processor circuit is to determine an adjustment of an output of the tool based on the characterization.

Example 4 includes the apparatus as defined in any of examples 2 or 3, wherein the threshold corresponds to a torque specification curve.

Example 5 includes the apparatus as defined in any of examples 1 to 4, further including a movable arm to contact the tool interface for simulation of a joint condition.

Example 6 includes the apparatus as defined in example 5, wherein the movable arm is rotatable about a pivot to contact a rotatable contoured body that is operatively coupled to the tool interface.

Example 7 includes the apparatus as defined in any of examples 1 to 6, wherein the brake includes a paddle to be at least partially submerged in fluid, the paddle operatively coupled to the tool interface.

Example 8 includes the apparatus as defined in any of examples 1 to 6s, wherein the brake includes a threaded shaft that supports a line carrying a mass, the threaded shaft operatively coupled to the tool interface.

Example 9 includes At least one non-transitory machine-readable medium comprising machine-readable instructions to cause at least one processor circuit to at least control a degree of braking of a rotational resistor, the rotational resistor to provide a force to a tool interface operatively coupled to a tool, determine an output of the tool corresponding to the controlled degree of braking, and characterize the tool based on the output and at least one of the (i) the force or (ii) the degree of braking.

Example 10 includes the at least one non-transitory machine-readable medium as defined in example 9, wherein the machine-readable instructions are to cause one or more of the at least one processor circuit to compare a first torque curve corresponding to the output to a second torque curve to characterize the tool.

Example 11 includes the at least one non-transitory machine-readable medium as defined in example 10, wherein the machine-readable instructions are to cause one or more of the at least one processor circuit to control a rotational speed of the tool to generate the first torque curve.

Example 12 includes the at least one non-transitory machine-readable medium as defined in example 11, wherein the machine-readable instructions are to cause one or more of the at least one processor circuit to determine an offset of the first and second torque curves to characterize the tool.

Example 13 includes the at least one non-transitory machine-readable medium as defined in any of examples 9 to 12, wherein the machine-readable instructions are to cause one or more of the at least one processor circuit to calibrate the tool based on the characterization.

Example 14 includes the at least one non-transitory machine-readable medium as defined in any of examples 9 to 13, wherein the machine-readable instructions are to cause one or more of the at least one processor circuit to control braking of the rotational resistor to maintain a torque imparted to the tool interface while determining the output.

Example 15 includes a method of characterizing a tool, the method comprising causing the tool to rotate at a defined setting, imparting a braking force at an interface of the tool, measuring an output at the interface of the tool, and comparing the output to the braking force to characterize the tool.

Example 16 includes the method as defined in example 15, further including causing a movable arm to contact a rotatable contoured body to simulate a joint condition, the rotatable contoured body operatively coupled to the interface.

Example 17 includes the method as defined in any of examples 15 or 16, further including calibrating the tool based on the comparison.

Example 18 includes the method as defined in any of examples 15 to 17, further including maintaining a rotational speed of the tool while measuring the output.

Example 19 includes the method as defined in any of examples 15 to 18, further including generating a torque curve based on the output, and comparing the torque curve to a threshold to characterize the tool.

Example 20 includes the method as defined in example 19, wherein the threshold corresponds to a reference torque curve.

From the foregoing, it will be appreciated that example systems, apparatus, articles of manufacture, and methods have been disclosed that enable controlled and accurate characterization, calibration and/or validation of tools. Examples disclosed herein can be implemented in a relatively quick and cost-effective manner.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to characterize a tool, the apparatus comprising:
a tool interface to be couplable to the tool;
a brake to apply a rotational resistance to the tool interface; and
a transducer to measure an output torque of the tool for characterization of the tool with respect to the rotational resistance.

2. The apparatus as defined in claim 1, further including:
interface circuitry;
machine-readable instructions; and
at least one processor circuit to be programmed by the machine-readable instructions to:
compare the output torque to a threshold; and
determine the characterization of the tool based on the comparison.

3. The apparatus as defined in claim 2, wherein one or more of the at least one processor circuit is to determine an adjustment of an output of the tool based on the characterization.

4. The apparatus as defined in claim 2, wherein the threshold corresponds to a torque specification curve.

5. The apparatus as defined in claim 1, further including a movable arm to contact the tool interface for simulation of a joint condition.

6. The apparatus as defined in claim 5, wherein the movable arm is rotatable about a pivot to contact a rotatable contoured body that is operatively coupled to the tool interface.

7. The apparatus as defined in claim 1, wherein the brake includes a paddle to be at least partially submerged in fluid, the paddle operatively coupled to the tool interface.

8. The apparatus as defined in claim 1, wherein the brake includes a threaded shaft that supports a line carrying a mass, the threaded shaft operatively coupled to the tool interface.

9. At least one non-transitory machine-readable medium comprising machine-readable instructions to cause at least one processor circuit to at least:
control a degree of braking of a rotational resistor, the rotational resistor to provide a force to a tool interface operatively coupled to a tool;
determine an output of the tool corresponding to the controlled degree of braking; and
characterize the tool based on the output and at least one of the (i) the force or (ii) the degree of braking.

10. The at least one non-transitory machine-readable medium as defined in claim 9, wherein the machine-readable instructions are to cause one or more of the at least one processor circuit to compare a first torque curve corresponding to the output to a second torque curve to characterize the tool.

11. The at least one non-transitory machine-readable medium as defined in claim 10, wherein the machine-readable instructions are to cause one or more of the at least one processor circuit to control a rotational speed of the tool to generate the first torque curve.

12. The at least one non-transitory machine-readable medium as defined in claim 11, wherein the machine-readable instructions are to cause one or more of the at least one processor circuit to determine an offset of the first and second torque curves to characterize the tool.

13. The at least one non-transitory machine-readable medium as defined in claim 9, wherein the machine-readable instructions are to cause one or more of the at least one processor circuit to calibrate the tool based on the characterization.

14. The at least one non-transitory machine-readable medium as defined in claim 9, wherein the machine-readable instructions are to cause one or more of the at least one processor circuit to control braking of the rotational resistor to maintain a torque imparted to the tool interface while determining the output.

15. A method of characterizing a tool, the method comprising:
causing the tool to rotate at a defined setting;
imparting a braking force at an interface of the tool;
measuring an output at the interface of the tool; and
comparing the output to the braking force to characterize the tool.

16. The method as defined in claim 15, further including causing a movable arm to contact a rotatable contoured body to simulate a joint condition, the rotatable contoured body operatively coupled to the interface.

17. The method as defined in claim 15, further including calibrating the tool based on the comparison.

18. The method as defined in claim 15, further including maintaining a rotational speed of the tool while measuring the output.

19. The method as defined in claim 15, further including:
generating a torque curve based on the output, and
comparing the torque curve to a threshold to characterize the tool.

20. The method as defined in claim 19, wherein the threshold corresponds to a reference torque curve.
